(19) United States
(12) Patent Application Publication
(10) Pub. No.: US 2009/0051617 A1
(43) Pub. Date: Feb. 26, 2009

(54) Rfid Transponder and its Blank and Method of Construction for Manufacturing the Rfid Transponder

(76) Inventors: Olavi Merilainen, Jyvaskyla (FI); Heikki Seppa, Helsinki (FI)

Correspondence Address: FILDES & OUTLAND, P.C., 20916 MACK AVENUE, SUITE 2, GROSSE POINTE WOODS, MI, 48236, US

(21) Appl. No.: 12/226,229

(22) PCT Filed: Apr. 24, 2007
(86) PCT No.: PCT/FI2007/050218

§ 371 Date: Oct. 9, 2008

(30) Foreign Application Priority Data
Apr. 28, 2006 (FI) 20065279

(51) Int. Cl. H01Q 1/38; H01Q 1/42

(52) U.S. Cl. 343/872; 343/700 MS

(57) ABSTRACT

The invention relates to an RFID transponder, which includes a case, a radiator, and a ground element, as opposed antenna elements, a ground plane intended to be set against the base at a distance from the radiator, and an electrical chip component. The radiator, ground element, and chip component are installed on a special foil, which also comprises the said ground plane on the first plane (A) and a fold between the first and second plane, the foil being thus divided into a first part on the first plane (A), the fold, and a second part on the second plane (B). The case has attached to it intermediate structure for supporting the first part and the second part of the foil on the said first plane (A) and second plane (B).

The present invention relates to an RFID transponder, which includes a case, a radiator, and a ground element, as opposed antenna elements, a ground plane intended to be set against the base at a distance from the radiator, and an electrical chip component, and in which the ground plane is on the first plane and the radiator is on the second plane, at a distance from the first plane, and in which the chip component is connected to the radiator and the ground element, and further in which the said radiator, ground element, and chip component are installed on a special foil. The invention also relates to a blank for the transponder. Here, the term RFID transponder refers mainly to a UHF-range passive transponder equipped with an RFID chip, but other applications too may be considered. Such RFID transponders operate using so-called backscatter technology. In this connection, reference is also made to so-called micro-strip antennae.

A passive RFID transponder is a small device comprising an antenna, microcircuit, and memory, which uses backscattering to transmit the contents of its memory when it receives a transmission command from a reading device and the reading device illuminates it with a radio signal. A passive transponder has no battery, but instead draws its operating power from the radio signal transmitted to it by the reader. The transmission of power and information between the transponder and the reader can take place with the aid of a magnetic field, an electric field, or a radiating radio signal. Active transponders have a battery and somewhat simpler operation, as power transmission is not needed.

Patent application publication US2004/0005754 A1 discloses one ‘smart label’ construction and a method for manufacturing it. Though the example in the publication concerns an inductively connecting RFID transponder, the same type of construction can also be applied to transponders operating at a radio frequency, which latter have a substantially greater range than the former. In the publication, polycarbonate, polyolefin, polyester, polyethylene terephthalate (PET), polyvinylchloride (PVC), and acrylonitrile/butadiene-styrene copolymer are presented as materials of the base web.

A challenge in RFID transponders operating in the UHF range is to make them operate reliably even on conductive surfaces. This is because the electrical properties of the antenna also depend on the properties of the installation surface. The effect of the base can be reduced sufficiently by equipping the transponder with a separate conductive shielding plane, above which the antenna is raised slightly. Another possibility is to use so-called PIFA (Planar Inverted F-antenna) antennae, in which the ground element of the antenna is formed of a sufficiently large surface area below the radiator. The totality is then less sensitive to the properties of the base and the transponder can generally be made to function on a conductive surface.

The manufacture of an PIFA antenna is difficult and expensive, particularly relating to the vias, due to the complexity of the construction. VTT (the Technical Research Centre of Finland) has published a basic solution (WO 2006/120287A1) for a so-called PAFFA antenna, which is intended to solve the problems relating to PIFA antennae. According to the abstract of the publication, a special folding technique in the antenna base is used to replace the vias of a PIFA antenna.

The present invention is intended to create a mechanical solution for reliably supporting the structures of an RFID transponder. The characteristic features of the transponder according to the invention are stated in the accompanying Claims 1. A blank for the transponder according to the invention is presented in Claim 9.

The invention can be applied to both RFID transponders equipped with a separate ground plane, and to transponders equipped with a newer PAFFA-type antenna structure. In one embodiment, the folded foil is supported on a special spacer piece, which keeps the planes of the foil at a distance to each other. In a second embodiment of the invention, the foil is supported directly on the side walls of the case. The solution applies generally to an antenna structure for a two-terminal antenna connection. A PAFFA antenna structure comprises a ground plane on the first surface, at least one transmission line on the second surface, connected to the ground plane through a fold in the edge of the antenna structure, in which case the fold acts as the primary source of the magnetic field, an insulator layer arranged between the first and second surface, and an electronic component, in which there is a two-terminal antenna, connected to the antenna structure. According to the solution, the electronic component is attached to the second surface of the antenna structure and connected from one of the antenna terminals to the transmission line and from the other terminal to either a second transmission line or to the fold.

Other embodiments and benefits of the invention are described hereinafter, in connection with examples of applications, which are shown in the accompanying drawings, in which

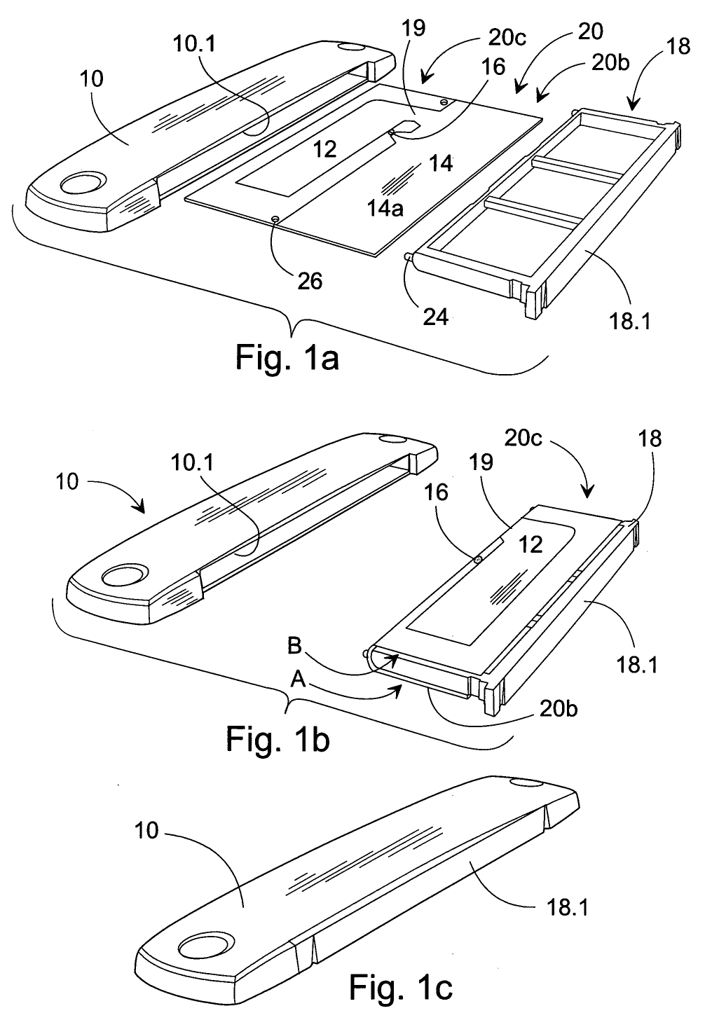

FIGS. 1a-1c show the construction and assembly of one RFID transponder according to the invention,

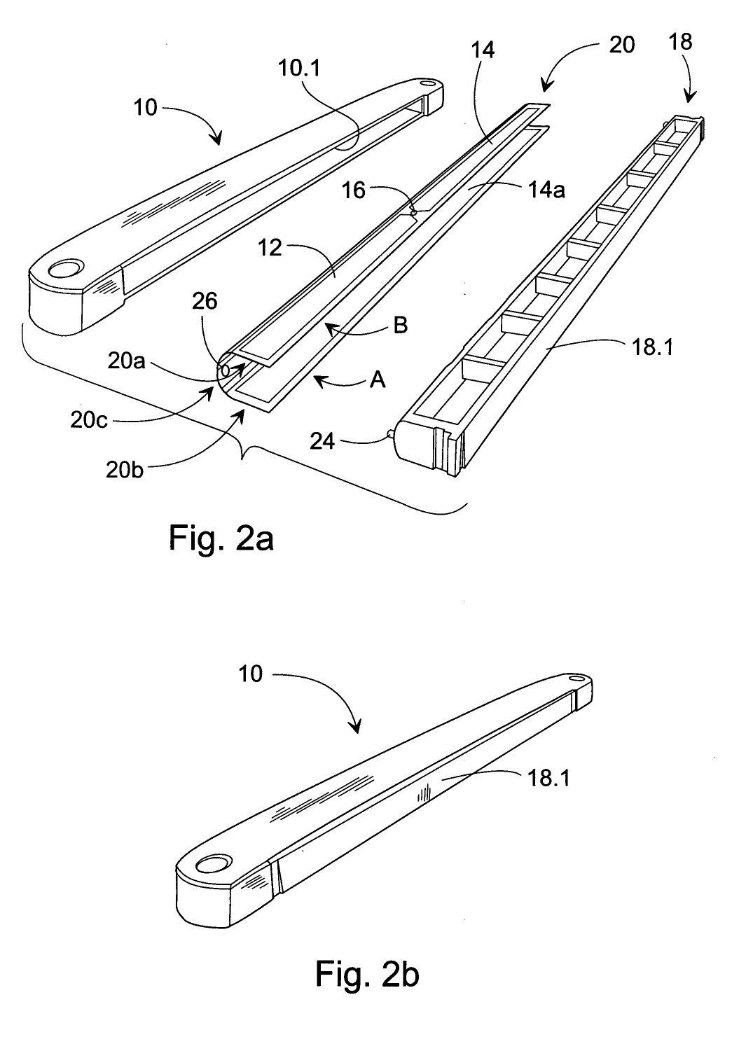

FIGS. 2a and 2b show a second assembly of the RFID transponder, and

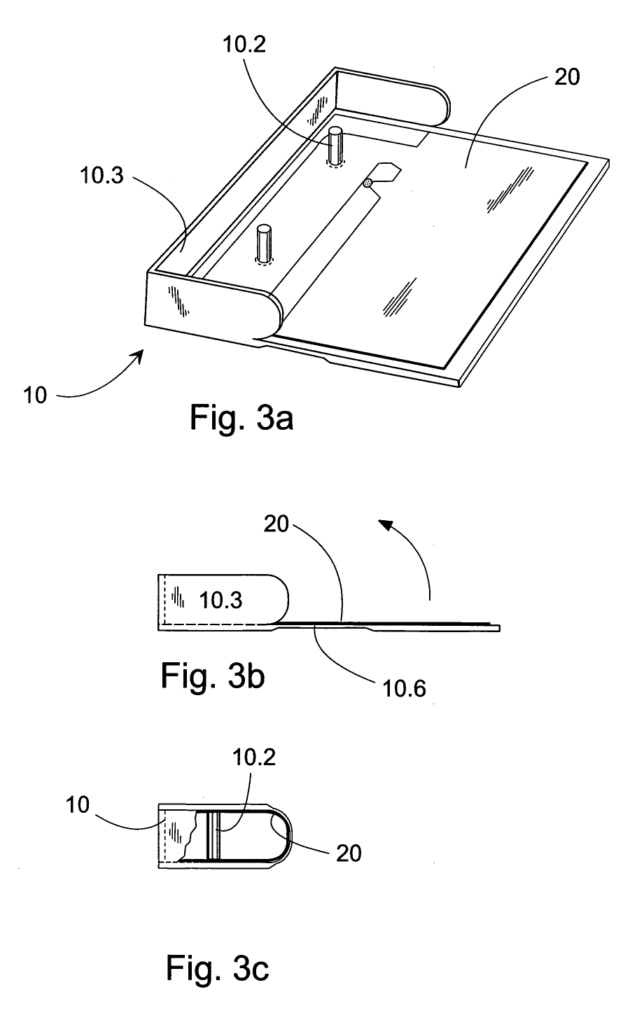

FIGS. 3a-3c show a blank for an RFID transponder, manufactured using the injection moulding technique, and its assembly.

In the embodiment of FIG. 1a-1c, the main components of the RFID transponder are a case 10, a foil 20, and an intermediate frame 18. There is an opening 10.1 in the side wall of the case 10 for the installation to be described later. The foil 20 is manufactured in some known manner and in it there are, as electrical elements, an electronic chip (RFID), radiator 12, ground element 14, which in this case also forms the ground plane 14a. The ground element 14 is connected by a transmission line 19 to the radiator at a distance from the feed point of the chip. The construction of the antenna element does not actually come within the scope of the present invention. Here, the frame 18 is for installing the foil 20. In the frame 18, there is a wall 18.1 covering the opening. To facilitate the installation of the foil, the front edge of the frame includes pins 24, with corresponding holes 26 in the foil, with the aid of which the foil can be precisely aligned as desired.

In the foil 20, there is a first part 20b, a fold 20a, and a second part 20c. When the foil 20 is folded on top of the frame 18 according to FIG. 1b, the first part 20b remains on the first plane A and the second part 20c remains on the second plane B. Thus, the frame 18 with the foil 20 can be pushed in, FIG. 1c. The joints can be, for example, welded using ultrasound, in order to create an airtight structure.

In this case, the foil 20, together with its insulation, folded to its final form, forms an RFID transponder with advantageous electrical properties. The length of the radiator is approximately λ/4 (ε=1, i.e. the air gap). At the example of a frequency of 867 MHz, the vertical-angle length from the free end of the radiator 12 to the middle of the transmission line 19 is 66 mm in the example according to the figure, in which the gap between the planes is 4 mm. It should be noted that the chip 16 is attached to the ground element 14 over a considerably shorted conductor length than λ/4. In this electrical application, the chip 16 is attached to the edge of the radiator at a point that corresponds to the impedance of the chip. In this relation, the location of the chip does not greatly affect the resonance frequency. According to FIG. 1b, the chip 16 remains on the same side as the radiator 12. The length of the electrical parts of the foil, in the direction of the fold, is preferably 4/√ε-15/√ε (cm), in which ε is the dielectric value of the substance between the first and second planes.

The assembly of FIG. 2a shows a second structure of an RFID transponder, which is based on a known dipole structure and a separate ground plane against the base. In this case, the radiator 12 and the ground element 14 are on the plane B with the chip 16 (part 20c of the foil 20). The electrically separate ground plane 14a is on plane A (part 20b of the foil 20). The fold 20a remains between these parts. A foil of this kind can be easily installed in the same way as above on top of the frame 18 and a rugged transponder structure created, FIG. 2b.

According to FIG. 3a, the blank 10′ for an RFID transponder can be manufactured by injection moulding, in such a way that the foil 20 is placed ready in the mould. In the blank there is a base plane and sides 10.3, as well as spacer pieces 10.2. One end of the plane can be turned, together with the foil, on top of the sides 10.3 and, for example, the joints welded together using ultrasound, when a transponder 10, installed in a case, will be created, which functionally corresponds to the transponder described above, depending on the electrical structures of the foil.

In the above, air is used between the planes. It is also possible to use a circuit-board material, or preferably plastic, which acts at the same time as the body of the transponder, as an intermediate substrate.

1. RFID transponder, which includes a case, a radiator, and a ground element, as opposed antenna elements, a ground plane intended to be set against the base at a distance from the radiator, and an electrical chip component, and in which the ground plane is on the first plane (A), and the radiator is on the second plane (B), at a distance from the first plane, and in which the chip component is connected to the radiator and the ground element, and, further, in which the said radiator, ground element, and chip component are installed on a special foil, characterized in that the said foil also comprises the said ground plane on the first plane (A) and a fold between the first and second plane, the foil being thus divided into a first part on the first plane (A), the fold, and a second part on the second plane (B), and intermediate structure relating to the case for supporting the first part and the second part of the foil on the said first plane (A) and second plane (B).

2. RFID transponder according to claim 1, characterized in that the ground plane is connected to form the ground element by a transmission line running through the fold.

3. RFID transponder according to claim 1, characterized in that the foil is attached to the inner surface of the case, the said intermediate structure thus being formed by the actual case.

4. RFID transponder according to claim 1, characterized in that the foil is supported on the internal intermediate structure carried by the case, which determines mechanically the distance of the first and second levels from each other, the said intermediate structure thus being formed mainly of the intermediate structure.

5. RFID transponder according to claim 1, characterized in that the intermediate structure is a frame creating mainly air insulation between the first and second planes.

6. RFID transponder according to claim 1, characterized in that the intermediate structure is board, which has a chosen dielectric value ε.

7. RFID transponder according to claim 4, characterized in that the intermediate structure is arranged to be pushed in through an opening in the wall of the case and the intermediate structure includes a wall covering the opening.

8. RFID transponder according to claim 1, characterized in that the length of the electrical components in the direction of the fold is 4/√ε-15/√ε, in which ε is the dielectric value of the substance between the first and second planes.

9. Blank for an RFID transponder, which includes a case-component blank, a foil comprising a ground plane, a ground element, a radiator, and a two-terminal chip component connected to the radiator and the ground element, and in which the said ground plane, ground element, radiator, and chip component are installed on the foil, characterized in that the case-component blank comprises a planar area and side elements at its edges and the foil is installed in a planar form on this area, which case-component blank is, together with the foil, arranged to be folded in two, to form a closed case, in which case the parts of the foil located on each side of the fold take up a position at a distance from each other.

10. Blank according to claim 9 for an RFID transponder, characterized in that the blank of the case component is an injection-moulded piece.

11. Method of construction for manufacturing an RFID transponder according to claim 1, in which the transponder is assembled from prefabricated components, which include a case and a foil containing the electrical components, and in which the foil is support on the case in a U shape, one branch containing a ground plane intended against the base, characterized in that an intermediate piece is formed, around which the foil is folded into the said U shape, after which the intermediate piece with the foil is pushed into the case and the intermediate piece is attached to the case.

12. Method of construction for manufacturing an RFID transponder according to claim 1, in which the transponder is assembled from prefabricated components, which include a case and a foil containing the electrical components, and in which the foil is supported on the case in a U shape, one branch containing a ground plane intended against the base, characterized in that the case blank is manufactured by injection-moulding as an essentially planar object and the foil is located as an inlay component in the mould before moulding and the finished blank with the foil is folded in two and finally the joints are closed, in order to create a closed case.
